(19) United States
(12) Patent Application Publication
(10) Pub. No.: US 2021/0049159 A1
(43) Pub. Date: Feb. 18, 2021

(54) Visualization and Validation of Cardinality-Constrained Groups of Data Entry Fields

(71) Applicant: International Business Machines Corporation, Armonk, NY (US)

(72) Inventors: Joachim Frank, Tuebingen (DE); Frank Groezinger, Dornhan (DE)

(21) Appl. No.: 16/541,522

(22) Filed: Aug. 15, 2019

(51) Int. Cl. G06F 16/242; G06F 16/215; G06F 16/904; G06F 16/21

(52) U.S. Cl. CPC G06F 16/244; G06F 16/211; G06F 16/904; G06F 16/215

(57) ABSTRACT

As disclosed herein, a method for applying a group cardinality constraint to a set of two or more input fields includes selecting a schema element corresponding to a set of two or more input elements, wherein the schema element comprises at least a data structure definition and a corresponding group construct, processing the group construct of the schema element to identify a data entry limitation corresponding to the set of two or more input elements, assigning a group cardinality constraint indicator to the identified data entry limitation, generating a set of two or more input fields corresponding to the set of two or more input elements, wherein each input field is annotated with the assigned group cardinality constraint indicator, and providing the generated set of two or more input fields to a user.

### BACKGROUND

The present invention relates generally to the field of data entry, and more specifically to the visualization and validation of cardinality-constrained groups of data entry fields.

Cardinality constraints, as used herein, refer to constraints on the number (cardinality) of data values required for a set of data entry fields in a user interface. Cardinality constraints define lower and upper bounds for the number of data values required and allowed, respectively, for data entry fields in a group. In other words, cardinality constraints define data entry limitations. Cardinality constraints of data entry fields are typically specified via data models or schemas describing the underlying data structures to be populated (filled with values). Cardinality constraints dictate to the user the requirements of filling the fields. Some constraints involve individual fields requiring mandatory or optional input, while other constraints may involve multiple fields. Examples of phrases corresponding to constraints involving multiple fields include “one of,” “many of,” “at least two of those three,” “this one or those two,” etc. User interface (UI) generators are used to generate visual indications of cardinality constraints on data entry fields. A commonly used visual indicator on data entry fields is an asterisk, which marks a mandatory input.

### SUMMARY

As disclosed herein, a method for applying a group cardinality constraint to a set of two or more input fields includes selecting a schema element corresponding to a set of two or more input elements, wherein the schema element comprises at least a data structure definition and a corresponding group construct, processing the group construct of the schema element to identify a data entry limitation corresponding to the set of two or more input elements, assigning a group cardinality constraint indicator to the identified data entry limitation, generating a set of two or more input fields corresponding to the set of two or more input elements, wherein each input field is annotated with the assigned group cardinality constraint indicator, and providing the generated set of two or more input fields to a user. A computer program product and a computer system corresponding to the method are also disclosed.

### BRIEF DESCRIPTION OF THE DRAWINGS

FIG. 1 is a block diagram depicting a data entry system in accordance with some embodiments of the present invention;

FIG. 2 is a flowchart depicting an extended UI generator logic method for generating visualizations for a group of input fields with a group cardinality constraint , in accordance with at least one embodiment of the present invention;

FIG. 3 is a flowchart depicting an extended UI generator logic method for generating visualizations of cardinality constraints for a group of input fields, in accordance with at least one embodiment of the present invention;

FIG. 4 is a flowchart depicting the extended UI generator logic method used for generating validation code for a group of input fields, in accordance with some embodiments of the present invention;

FIG. 5A is a set of expressions defining cardinality constraints for groups of input fields in accordance with an embodiment of the present invention;

FIG. 5B is a data definition with a group cardinality constraint in accordance with an embodiment of the present invention;

FIG. 6A is a data definition with both a group cardinality constraint and an individual data value constraint in accordance with an embodiment of the present invention;

FIG. 6B is example user interface code and group cardinality constraint validation logic in accordance with an embodiment of the present invention; and

FIG. 7 is a block diagram of components of a computing system executing the user interface generator, in accordance with some embodiments of the present invention.

### DETAILED DESCRIPTION

Existing implementations of software used to generate data entry fields based on given data models can generate visual representations of data entry requirements, but only for a single input field. This ability trivially extends to groups of entry fields where each field requires a value. A commonly used visual indicator for data entry fields is an asterisk, which marks a mandatory input field. However, state of the art UI generators cannot generate visual representations of data entry constraints involving multiple fields and constraints requiring some, but not all, of those fields to receive values. Instead UI generators alert users of missing or excess values after data has been entered and submitted, resulting in tedious back out and reentry. Furthermore, failure to prompt users with visualizations up front can lead to unnecessary effort and excessive data entry when a subset of all the information provided would have sufficed.

There exist various methods for expressing constraints for groups of fields in code. For example, XML Schema Definition (XSD) can express group cardinality constraints by defining a minimum number of entries required (“minOccurs”) and a maximum number of entries allowed (“maxOccurs”) that can be used to define requirements like “one or more,” “at least two of those three,” “either this one or those two,” etc. The current state of the art UI generators however cannot generate forms that contain visualizations of these group constraints. For example, a particular form containing two data entry fields may require a value for at least one of the two fields. Using existing UI generators, mandatory indicators may be placed next to each field, even though the data definition only requires completion of one. Current solutions may remove the mandatory indicator of empty fields once the required minimum entries of the group have been completed through data entry in other fields. This sudden change of the input constraints can easily go unnoticed and is reliant on a response time from the system (as it requires the system to dynamically monitor the input fields as a user is manipulating the input fields). In addition, the initial display of mandatory indicators next to each data entry field may have prompted the user to fetch and prepare more data for entry than the application actually requires. These situations can cause confusion, and lead to misrepresentations and unnecessary data preparation and input, as the user is unsure of which fields must be completed.

The present invention will now be described in detail with reference to the Figures. Implementation of embodiments of the invention may take a variety of forms, and exemplary implementation details are discussed subsequently with reference to the Figures.

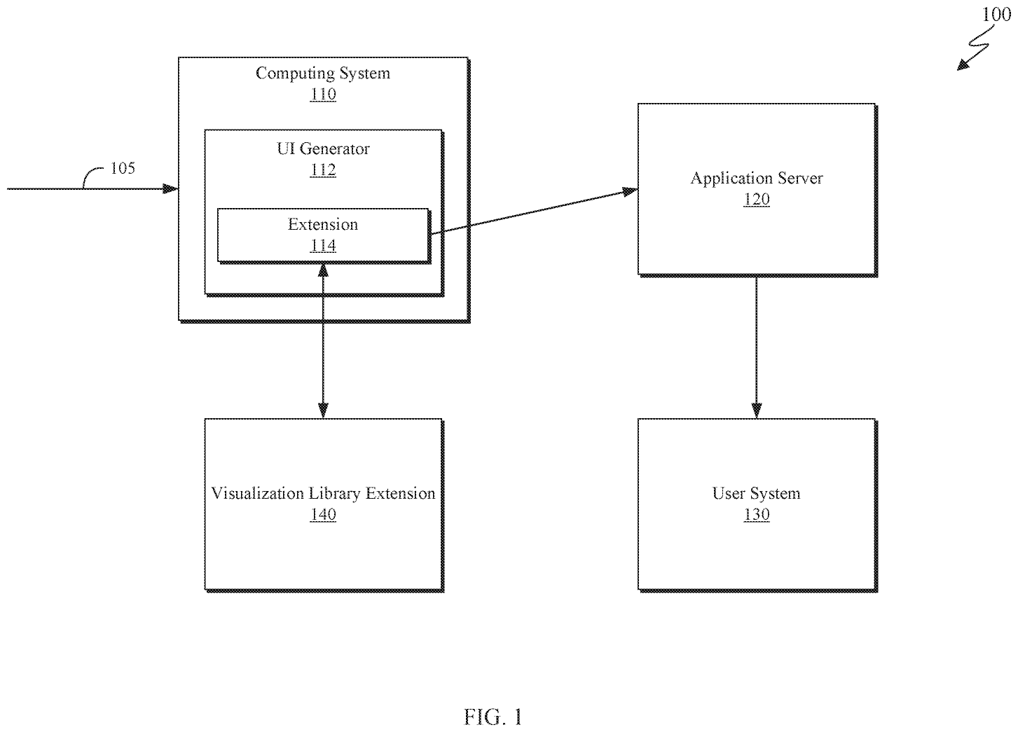

FIG. 1 is a functional block diagram depicting data entry system 100 in accordance with some embodiments of the present invention. As depicted, data entry system 100 includes computing system 110, application server 120, user system 130, and visualization library extension 140.

Computing system 110 can be a desktop computer, a laptop computer, a specialized computer server, or any other computer system known in the art. In some embodiments, computing system 110 represents computer systems utilizing clustered computers to act as a single pool of seamless resources. In general, computing system 110 is representative of any electronic device, or combination of electronic devices, capable of receiving and transmitting data, as described in greater detail with regard to FIG. 7. Computing system 110 may include internal and external hardware components, as depicted and described in further detail with respect to FIG. 7.

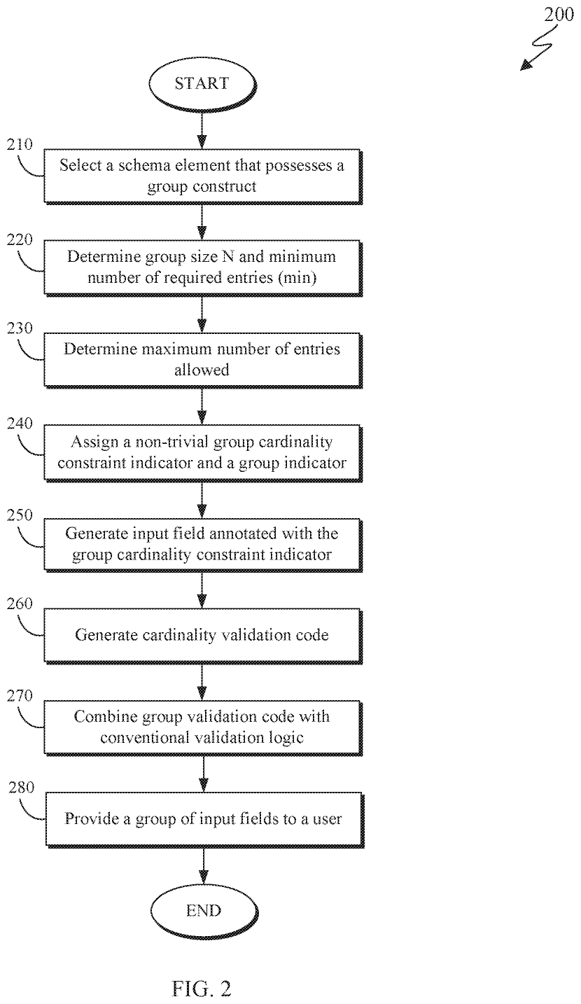

As depicted, computing system 110 comprises UI generator 112. UI generator 112 may be a state-of-the-art UI generator capable of receiving data definition 105 and parsing the data to generate UI elements for individual, required, or optional data entry fields. Data definition 105 may be expressed using any data description language, including but not limited to, XML Schema Definition (XSD). In at least one embodiment, UI generator 112 is extended with a module capable of generating visualizations and validation code for a group of input fields with group cardinality constraints, such as the depicted UI generator extension 114. UI generator extension 114 may be a module integrated with UI generator 112. UI generator extension 114 is capable of generating visualizations and validation code for a group cardinality constrained group of input fields. In at least one embodiment, UI generator extension 114 is configured to execute UI generator logic method 200. One embodiment of an appropriate UI generator logic method 200 is described with respect to FIG. 2.

Application server 120 may be a system software upon which web applications run. In some embodiments, application server 120 may be a hardware device upon which web applications run. Application server 120 may consist of web server connectors, computer programming languages, data base connectors, etc. In some embodiments, application server 120 may be used to support the construction of dynamic web pages which may include, but are not limited to, data entry forms. In general, application server 120 is capable of receiving code from UI generator 112 and transmitting the received code to user system 130 for user input. In at least one embodiment, application server 120 may additionally be configured to alter the received code in some manner.

User system 130 may be a desktop computer, laptop computer, tablet computer, or any other user system known in the art. In general, user system 130 is representative of any electronic device or devices capable of receiving data input forms and displaying those forms to a user. User system 130 may additionally be capable of enabling a user to manipulate a data form by manually entering data or interacting with a set of one or more options to indicate a choice or selection.

Visualization library extension 140 may be implemented to generate visualizations for group cardinality constraints that a state-of-the-art UI generator is not capable of generating. In at least one embodiment, visualization library extension 140 is capable of (1) receiving data from UI generator extension 114 that defines the group cardinality constraint for the data input field and (2) transmitting corresponding indicators for all input fields. While visualization library extension 140 is depicted as being externally connected to computing system 110, it should be appreciated that in other embodiments, visualization library extension 140 may exist internally on computing system 110.

While the depicted embodiment shows computing system 110, application server 120, user system 130, and visualization library extension 140 being operably connected, it should be appreciated that this is only one of many embodiments of an appropriate data entry system. In other embodiments, each component of data entry system 100 may be connected via a network. Examples of an appropriate network include, for example a local area network (“LAN”), a wide area network (“WAN”) such as the Internet, or a combination of the two, and may include wired, wireless, or fiber optic connections. In general, an appropriate network can be any combination of connections and protocols that will support communications between computing system 110, application server 120, user system 130, and visualization library extension 140.

FIG. 2 is a flowchart depicting an extended user interface (“UI”) generator logic method 200 used to generate visualizations for a group of input fields with a group cardinality constraint in accordance with at least one embodiment of the present invention. As depicted, extended UI generator logic method 200 includes selecting (210) a schema element that possesses a group construct, determining (220) a size of the group (N) and a minimum number of entries required in the group, determining (230) a maximum number of entries allowed with respect to the minimum number of entries required and N, assigning (240) a group cardinality constraint indicator and a group indicator, generating (250) an input field annotated with the group cardinality constraint indicator and the group indicator, generating (260) a cardinality validation code for the group of input fields, combining (270) the validation code generated for the group of input fields with conventional validation logic, and providing (280) a group of input fields to a user according to the group cardinality constraint and the generated validation code.

Selecting (210) a schema element that possesses a group construct may include a UI generator extension 114 parsing a data set to identify a data structure definition corresponding to a schema element. In some embodiments, the schema element possesses a group construct. A group construct may be identified in a data set that includes a group cardinality constraint. A group cardinality constraint may be defined as a data entry constraint applying to multiple input fields that comprise a group of input fields. In some embodiments, the UI generator extension 114 may process the schema element and any additional information received corresponding to the schema element to determine whether the schema element possesses a group construct. In another embodiment, the UI generator extension 114 may select a schema element already known to possess a group construct. In an embodiment where the schema element is expressed using XML Schema, a group construct may exist where the schema definition contains more than one distinct element. In other words, in such an embodiment, the schema definition includes multiple input fields. In other embodiments, other formats may be used to express the data definition, either independently or in combination with one another.

Determining (220) a size of the group (N) and a minimum number of entries required (min) in the group may include the UI generator extension 114 processing the schema element to determine a total number of elements contained in the group. Determining (220) a size of the group (N) and a minimum number of entries required (min) in the group may additionally include the UI generator extension 114 processing the schema element to identify the min in the group of input fields. In an embodiment where the number of entries required is neither N nor zero (in other words, an entry in some, but not all, of the input fields is required), the schema element is said to include a group cardinality constraint. In an embodiment where the number of entries required equals N (in other words, an entry in all input fields is required), the schema element does not include a group cardinality constraint. In an embodiment where the number of entries required equals zero (in other words, an entry in all input fields is optional), the schema element does not include a group cardinality constraint. In an embodiment where the schema element is expressed using XML Schema, N is defined by the number of distinct elements that comprise the group of elements and the minimum is defined by a value for “minOccurs.”

Determining (230) the maximum number of entries allowed (max) with respect to the minimum number of entries required (min) and N may include the UI generator extension 114 processing the schema element to identify the max and comparing that value with the min. Determining (230) the maximum number of entries allowed (max) with respect to the minimum number of entries required (min) and N may additionally include the UI generator extension 114 processing the schema element to identify the max and comparing the identified max value with N. In an embodiment where the max equals the min, the required number of entries is considered “fixed.” In an embodiment where the max equals N, there is no upper limit on the number of entries allowed. In such an embodiment, the number of entries allowed may be considered “limitless” or “unlimited.” In an embodiment where the max equals neither the min nor N, the number of entries allowed is a range between the min and the max. In an embodiment where the schema element is expressed using XML Schema, the max is defined by a non-zero value for “maxOccurs.”

Assigning (240) a group cardinality constraint indicator and a group indicator may include the UI generator extension 114 annotating the schema element with a group cardinality constraint indicator. A group cardinality constraint indicator may be used to convey to the user the input required and allowed for a group of input fields bound by a shared cardinality constraint. Assigning (240) a group cardinality constraint indicator and a group indicator may additionally include the UI generator extension 114 annotating the input field with a group indicator. A group indicator may be used to convey, to the user, which individual input fields are bound by the same cardinality constraint. In at least one embodiment, a group cardinality constraint indicator may be informed by the determination made in step 230, which determines the maximum number of entries allowed (max) with respect to the minimum number of entries required (min) and N. In another embodiment, a selected group indicator may be assigned. In at least one embodiment, a group indicator may be informed by the determination made in step 210. In another embodiment, a selected group indicator may be assigned. Examples of indicators include, but are not limited to, symbols, letters, numbers, colors, and block/frame constructs. In an embodiment where a schema element is comprised of four elements (N=4), requires a minimum of two entries (min=2), and allows a maximum of three entries (max=3), an expression of the group cardinality constraint with the group indicator may be, but is not limited to, “(2 . . . 3)^{A}”, indicating to the user that completion of at least two but no more than three of the four input fields are required, and that all input fields annotated with a superscript “A” belong to the same group.

Generating cardinality constraint indicators for groups of data entry fields requires that (1) the data entry fields belonging to a constrained group of fields are marked in some way that shows their logical grouping, and (2) the minimum number of entries required and maximum number of entries allowed be specified. In at least some embodiments, various combinations of symbols, letters, and numbers may be used to illustrate the grouping of entry fields. For example, each entry field belonging to the same group may be annotated with a common symbol or the same number. Symbols, letters, and numbers may also be used to describe the cardinality constraint. For example, “(1 . . . 1)$” may be used to indicate that each entry field marked with the dollar sign is part of the same group, and that exactly one entry (1 . . . 1) is required for that group. In this example, the two numbers indicate the minimum number of entries required and maximum number of entries allowed. An alternative notation might be “(1)$” meaning “exactly 1 entry field of the group marked by dollar sign requires a value.”

Color coding may be used to illustrate the grouping of entry fields. For example, the border of each entry field belonging to a group may be outlined in the same color. Color coding may also be used in combination with other indicators, including but not limited to, symbols, letters, and numbers. For example, entry fields may be marked with color coded symbols, where all fields belonging to the same group share the same colored symbol.

Blocking/framing may be used to illustrate the grouping of entry fields. For example, fields belonging to the same group may be enclosed by a block/frame marker. Blocking/framing may be used in combination with other indicators, including but limited to, symbols, letters, and numbers. For example, a blocked/framed group of entry fields may also be annotated with a “(0 . . . 2)” indicating that up to two entry fields in this group may be completed, but none are required.

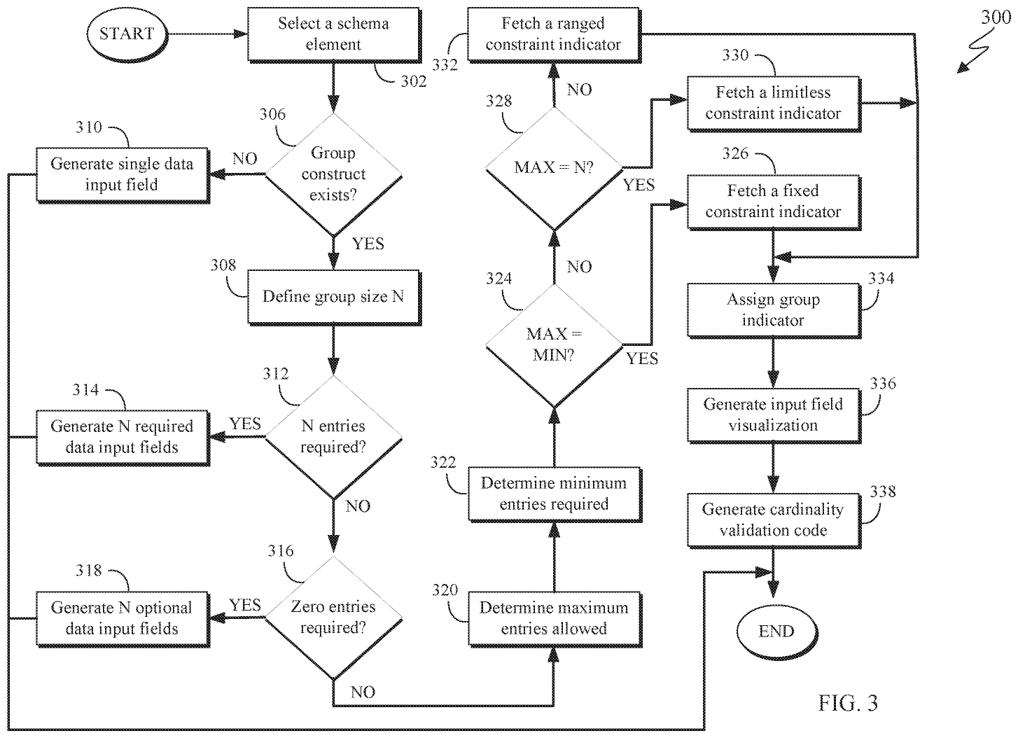

Generating (250) an input field annotated with the group cardinality constraint indicator and the group indicator may include the UI generator extension 114 processing the schema element and producing N data input fields with corresponding group cardinality constraint indicators and group indicators. In at least one embodiment, the UI generator extension 114 may fetch an indicator from an external visualization library that contains new entries for mapping group constraints to UI graphical elements. In some embodiments, the corresponding group cardinality constraint indicators and group indicators may reflect the assignment made in step 240. In another embodiment, the corresponding group cardinality constraint indicators and group indicators may reflect selected information. In at least one embodiment, the input field annotated with the group cardinality constraint indicator and the group indicator will be generated by a UI generator extension 114 in accordance with method 300 depicted with respect to FIG. 3.

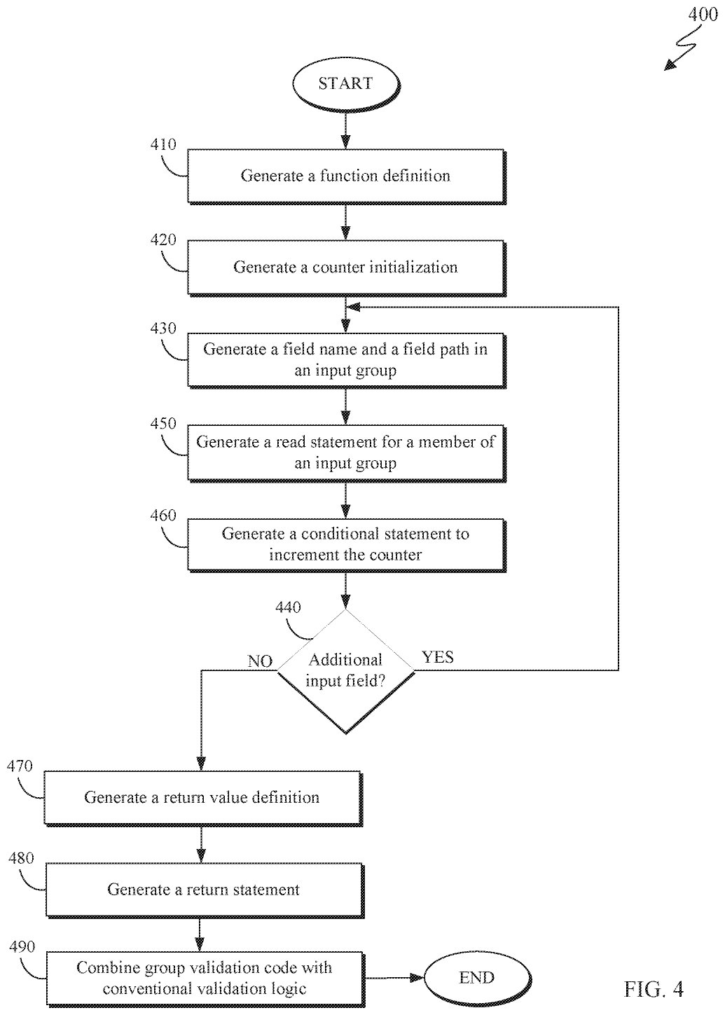

Generating (260) cardinality validation code for the group of input fields may include the UI generator extension 114 generating code for processing the group of input fields annotated with a group cardinality constraint indicator and a group indicator. The UI generator extension 114 may parse the schema element to determine the min and max assigned to the group, and then generate code to determine the number of valid inputs in accordance with those values. The UI generator extension 114 may then generate a conditional increment counter that processes the data input fields to determine whether each individual input conforms to one or more schema defined value constraints and incrementing the counter by a user defined value if the data values entered by the end user satisfy these constraints. Examples of data value constraints applied to an individual input field include, but are not limited to, length of input, data type, and pattern. The UI generator extension 114 may then generate code to determine whether the counter's tally is between the min and max, inclusive and generate a statement to accordingly return a true or false result. The conjunction of these results for all groups of data entry fields in the generated UI, together with the validation results for the conventionally validated, individual data entry fields in the UI, determines whether the generated data entry form is accepted for submission. In at least one embodiment, the cardinality validation code is generated in accordance with method 400 as discussed with respect to FIG. 4.

Combining (270) the group validation code with conventional validation logic may include the UI generator extension 114 adding the previously created cardinality validation code to conventional UI generator code for cardinality constraints. In at least some embodiments, combining (270) the group validation code with conventional validation logic may include adding conventional validation logic to the cardinality validation code as it is created; in other words, bits of conventional logic may be incorporated into the cardinality validation code by the UI generator extension 114 as it is being created.

Providing (280) a group of input fields to a user according to the group cardinality constraint and the generated validation code may include the UI generator deploying the code produced in step 270, and the application server to which it was deployed displaying, upon request for data entry by an end user a fillable form with group cardinality constraint visualizations to the end user. In at least one embodiment, an external application server may be used to receive the code and display the form. In at least one embodiment, HTML may be used to construct the user interface.

FIG. 3 is a flowchart depicting extended UI generator logic method 300 used for generating visualizations of a cardinality constraint for a group of input fields in accordance with at least one embodiment of the present invention. As depicted, an extended UI generator logic method for generating visualizations of group cardinality constraints includes selecting (302) a schema element, determining (306) whether the schema element possesses a group construct, defining (308) a size of a group (N) , generating (310) a single data input field with an annotation for an individual cardinality constraint, determining (312) whether an entry in N input fields in the group are required, generating (314) N required data input fields with an annotation for required entry, determining (316) whether zero entries are required, generating (318) N optional data input fields with an annotation for optional entry, determining (320) a maximum number of entries allowed, determining (322) a minimum number of entries required, determining (324) whether the maximum number of entries allowed equals the minimum number of entries required, fetching (326) a group cardinality constraint indicator corresponding to a number of entries that is considered “fixed,” determining (328) whether the maximum number of entries allowed equals N, fetching (330) a corresponding group cardinality constraint indicator if the maximum number of entries allowed equals N, fetching (332) a corresponding group cardinality constraint indicator if the maximum number of entries allowed does not equal the minimum or N, assigning (334) a group indicator to the schema-defined group construct, generating (336) visualizations of input fields for all members of the schema-defined group construct annotated with the group cardinality constraint indicator and the group indicator, and generating (338) validation logic for the cardinality constrained group of input fields.

Selecting (302) a schema element may include UI generator 112 receiving a data set. In at least one embodiment, the received data set may be expressed using XML Schema.

Determining (306) whether the schema element possesses a group construct may include UI generator extension 114 parsing the schema to identify a data structure definition corresponding to the schema element. In at least one embodiment, the data structure definition includes group cardinality constraints. In an embodiment where the schema element is expressed using XML Schema, a group construct may exist where the schema definition contains more than one distinct element, in other words, in such an embodiment, the schema definition includes multiple input fields. If the schema element possesses a group construct (306, yes branch), then the method continues by defining (308) a size of a group N indicated by the group construct. If the schema element does not possess a group construct (306, no branch), then the method continues by generating (310) a single data input field with an annotation for an individual cardinality constraint according to methods known in the art.

Defining (308) a size of a group N may include UI generator extension 114 totaling the number of elements contained in the group construct. For example, in a scenario in which four elements comprise a group, N equals four. In an embodiment where the method is ongoing, or executed recursively, UI generator extension 114 keeps a running tally of the number of elements contained in the schema as it identifies them. In other embodiments, UI generator extension 114 waits to total the number of elements contained in the group construct until the number of elements is finalized.

If the schema element does not possess a group construct (306, no branch), then the method continues by generating (310) a single data input field with an annotation for an individual cardinality constraint. Generating (310) a single data input field with an annotation for an individual cardinality constraint may include UI generator 112 processing the schema element and producing a single data input field. Generating (310) a single data input field may additionally include generation of annotations corresponding to the cardinality constraint. In at least one embodiment, an annotation reading “required” may be generated using conventional UI generator logic. In at least one embodiment, an annotation reading “optional” may be generated using conventional UI generator logic. In at least one embodiment, no annotation may be generated.

Determining (312) whether an entry in N input fields that comprise the group is required may include UI generator extension 114 parsing the schema element to identify the number of entries required for the group of input fields. If the number of entries required is equal to N (312, yes branch), then the method continues by generating (314) N required data input fields with an annotation for required input. If the number of entries required does not equal N (312, no branch), then the method continues by determining (316) whether no entries are required.

Generating (314) N required data input fields with an annotation for required input may include UI generator 112 processing the schema element and producing N data input fields with corresponding annotations. Annotations for data input fields may be visual representations used to convey to the user what action the user must or may take. In at least one embodiment, an annotation reading “required” may be generated using conventional UI generator logic. In another embodiment, no annotation may be generated.

If the number of entries required does not equal N (312, no branch), the method continues by determining (316) whether zero entries are required. Determining (316) whether zero entries are required may include UI generator extension 114 parsing the schema element to identify the number of entries required for the group of input fields. If the number of entries required is zero (316, yes branch), then the method continues by generating (318) N optional data input fields with an annotation for optional input. If the number of entries required is not equal to zero (316, no branch), then the method continues by determining (320) a minimum number of entries required.

Generating (318) N optional data input fields with an annotation for optional input may include UI generator 112 processing the schema element and producing N data input fields with corresponding annotations. In at least one embodiment, an annotation reading “optional” may be generated using conventional UI generator logic. In another embodiment, no annotation may be generated.

Determining (320) the maximum number of entries allowed (max) may include UI generator 112 parsing the schema element to identify the max for the group of input fields. In an embodiment where the schema element is expressed using XML Schema, the max is defined by a non-zero value for “maxOccurs.”

Determining (322) the minimum number of entries required (min) may include UI generator 112 parsing the schema element to identify the min for the group of input fields. In an embodiment where the schema element is expressed using XML Schema, the min is defined by a non-zero value for “minOccurs.”

Determining (324) whether the max equals the min may include UI generator extension 114 comparing the value determined in step 320 with the value determined in step 322. If the max equals the min (324, yes branch), then the required number of entries is considered “fixed,” and the method continues by fetching (326) a corresponding fixed group cardinality constraint indicator. If the max does not equal the min (324, no branch), then the method continues by determining (328) whether the max equals N, that it, the number of elements in the group construct.

Fetching (326) a group cardinality constraint indicator corresponding to a number of entries that is considered “fixed” may include UI generator extension 114 retrieving a group cardinality constraint indicator. In some embodiments, UI generator extension 114 may retrieve the indicator from a visualization library extension 140. In other embodiments, UI generator extension 114 may be outfitted with a visualization library. In an embodiment where the schema element is expressed using XML Schema, UI generator extension 114 may retrieve an indicator from an XML visualization library extension. For example, the indicator may be, but is not limited to, “(1)” or “(*).”

If the maximum number of entries allowed does not equal the minimum number of entries required (324, no branch), the method continues by determining (328) whether the maximum number of entries allowed equals N. Determining (328) whether the max equals N may include UI generator extension 114 comparing the value determined in step 322 with the value determined in step 308. If the max equals N (328, yes branch), then there is no upper limit on the number of entries allowed (i.e. the number of entries allowed is “unlimited” or “limitless”) and the method continues by fetching (330) a corresponding group cardinality indicator. If the max does not equal N (328, no branch), then the number of inputs allowed is a range between the min and the max. If the aforementioned is true, then the method continues by fetching (332) a “ranged” group cardinality indicator.

Fetching (330) a group cardinality constraint indicator corresponding to a number of entries that is “unlimited” or “limitless” may include UI generator extension 114 retrieving a group cardinality constraint indicator. In some embodiments, UI generator extension 114 may retrieve the indicator from visualization library extension 140. In other embodiments, the UI generator may be outfitted with a visualization library. In an embodiment where the schema element is expressed using XML Schema, UI generator extension 114 may retrieve an indicator from an XML visualization library extension. For example, an indicator may be, but is not limited to, “(2 . . . ),” indicating two required entries but up to N allowed entries.

Fetching (332) a group cardinality constraint indicator corresponding to a range of entries between the minimum number required and the maximum number allowed may include UI generator extension 114 retrieving a ranged group cardinality constraint indicator. In at least one embodiment, UI generator extension 114 may retrieve the indicator from visualization library extension 140. In other embodiments, UI generator extension 114 may be outfitted with a visualization library. In another embodiment, UI generator 112 may be outfitted with a visualization library. In an embodiment where the schema element is expressed using XML Schema, UI generator extension 114 may retrieve an indicator from an XML visualization library extension. For example, an indicator may be, but is not limited to, “(1 . . . 3),” indicating at least one entry is required but no more than 3 entries are allowed.

Assigning (334) a group indicator for the schema-defined group construct may include UI generator extension 114 assigning a letter, number, color, symbol, or block/frame construct. Color coding may be used to indicate to the user all input fields that belong to the group. Blocks/frames may be used to enclose the input fields belonging to the group. Symbols, letters, and numbers may be used to indicate to the user which input fields belong to the same group by assigning the same symbol, letter, or number to all input fields comprising the same group.

Generating (336) visualizations of input fields for all members of the schema-defined group annotated with the group cardinality constraint indicator and the group indicator may include UI generator 112 producing the annotated group of input fields. In general, any process known in the art for generating input fields for a user's manipulation and a corresponding annotation may be appropriate for use here.

Generating (338) cardinality validation code for the group of input fields may include UI generator extension 114 processing the schema element. UI generator extension 114 may parse the schema element to determine the min and max assigned to the group, and then generate a return value definition in accordance with those values. UI generator extension 114 may then generate a conditional increment counter which processes the data input fields to determine whether each individual input conforms to one or more schema defined data values constraints and increment the counter by a user defined value if the constraints are satisfied. Examples of schema-defined data value constraints applied to individual input fields include, but are not limited to, length of input, data type, and pattern. The generated code will, as data values are entered into the generated input fields by a user and the generated conditional counter is incremented for each valid data item, determine whether the counter's tally is between the min and max, inclusive and return a result indicating whether that is true. Using methods well-known from conventional UI generators, the result can be used to show a visual indication to the user that the data values entered in the group construct do not meet its constraints (error pop-up; highlighting with red color; etc.). In at least one embodiment, the cardinality validation code is generated in accordance with method 400 as discussed with respect to FIG. 4.

FIG. 4 is a flow chart depicting extended UI generator logic method 400 used for generating validation code for a group of input fields in accordance with at least one embodiment of the present invention. As depicted, extended UI generator logic method 400 includes generating (410) a function definition, generating (420) a counter initialization, generating (430) a field name and path of a field in an input group, generating (450) a read statement for a member field value, generating (460) a conditional statement to increment the counter, determining (440) whether an additional element in a group exists, generating (470) a return value definition, generating (480) a return statement, and combining (490) a group validation code with conventional validation logic.

Generating (410) a function definition may include UI generator extension 114 receiving a group of input fields and corresponding group information. UI generator extension 114 may then process the received input group information to provide a function definition corresponding to the group. The function definition may be defined as a function that checks the cardinality of valid data values entered into the generated fields of the input group. In at least one embodiment, UI generator extension 114 may use the group indicator of the group to generate the function definition. In another embodiment, UI generator extension 114 may use the group number of the group to generate the function definition. In another embodiment, UI generator extension 114 may use both the group indicator and the group number of a group to generate the function definition. In an embodiment using JavaScript, the function definition may be expressed as “check_cardinality_<input_group>( )” where “input_group” defines a sequence of multiple elements that comprise a group of inputs sharing a group cardinality constraint . In other embodiments, appropriate expressions for defining one or more functions in additional program languages may be utilized.

Generating (420) a counter initialization may include UI generator extension 114 setting a “zero” value for the function definition generated in step 410. In some embodiments, a user indicated value may be generated to set the “zero” value for the function definition. In other embodiments, UI generator extension 114 may identify an optimal “zero” value of the function definition. In an embodiment using JavaScript, the counter initialization may be defined by “num_entered=0,” where the “zero” value of the 410 function definition is 0. In other embodiments, an appropriate expression for setting a counter initialization value in any programming language may be utilized.

Generating (430) a field name and path of a field in a group of input fields may include UI generator extension 114 parsing the schema to identify a name of each member of a schema defined group of input fields with a shared cardinality constraint. Generating (430) a field name and path of a field in a group of input fields may additionally include parsing the schema to identify the location of a member in the schema. In some embodiments, the field name may correspond with the name of an individual element within a group of input fields bound by a group cardinality constraint . In some embodiments, a path of the field may be identified by the location of a member element within a group of input fields. In an embodiment where the data definition is expressed using XML Schema, the field name may correspond to an individual element name, and the path to the field may correspond to the name of a “complexType” where “complexType” defines an element that contains other elements.

Generating (450) a read statement for a member of a group of input fields may include UI generator extension 114 generating code to fetch a value from an input field generated according to the data definition and assign it to a corresponding input field variable. In some embodiments, the value of a member is fetched using the path identified in step 430 and assigned to the corresponding input field variable using the name of the member element identified in step 430. In an embodiment where validation logic is expressed using JavaScript, the generated statement may be presented as “<field_name>_value =<path_to_field>.value” where “<field_name>” corresponds to the name of an individual member of the group of input fields and “<path_to_field>” corresponds to its location in the data definition. In other embodiments, an appropriate expression for fetching a data value from an input field in a user interface in any programming language may be utilized.

Generating (460) a conditional statement to increment the counter may include UI generator extension 114 generating code to process the input fields to determine whether an input conforms to one or more schema-defined data value constraints. In at least some embodiments, the data value constraints correspond to data type definitions in the schema. Value constraints for a data input field may include, but are not limited to, input length, datatype, and pattern. Such data value constraint validations, as they apply to each member input field individually, can be generated using conventional UI generator logic. The generated conditional increment for the counter will perform an increment if the generated constraint validation for a value fetched by the read statement generated in (450) succeeds. In an embodiment where the validation logic is expressed using JavaScript, the generated conditional increment for the counter may be presented as “if isValid(dield_name>_value) num_entered+=1” where “<field_name>” corresponds to the name of an individual element in the group of inputs and “num_entered+=1” increases the counter by one with each valid input. In other embodiments, an appropriate expression for conditionally incrementing a counter in any programming language may be utilized.

Determining (440) whether an additional input field exists may include UI generator extension 114 parsing a data definition to identify additional members of a group of input fields. If an additional member of a group of input fields exists (440, yes branch), then the method applies 430, 450, and 460 to each additional member element. If an additional member element for a given group of input fields does not exist (440, no branch), then the extended UI generator logic continues.

Generating (470) a return value definition may include UI generator extension 114 processing the received group information to determine the value of the minimum number of entries required and the maximum number of entries allowed. The UI generator may then use the minimum and maximum to define the lower and upper limits of the return value definition, respectively. In an embodiment using JavaScript, the return value definition may be expressed as “check_ok=num_entered>=min && num_entered<=max” where the min and max correspond to the minimum number of entries required and maximum number of entries allowed, respectively. In other embodiments, appropriate expressions for defining one or more comparisons in additional program languages may be utilized.

Generating (480) a return statement may include UI generator extension 114 generating code to set a Boolean return value based on the counter's final tally. If the final tally is between the minimum and maximum, inclusive, then the Boolean return value is true. If the final tally is outside the minimum and maximum, inclusive, then the Boolean return value is false. In an embodiment using JavaScript, the return statement may be expressed as “return check_ok.”

Combining (490) a group validation code with conventional validation logic may include UI generator extension 114 merging the group validation code with conventional validation code. In at least some embodiments, combining (490) the group validation code with conventional validation logic may include adding conventional validation logic to the cardinality validation code as it is created; in other words, bits of conventional logic may be incorporated into the cardinality validation code as it is being created.

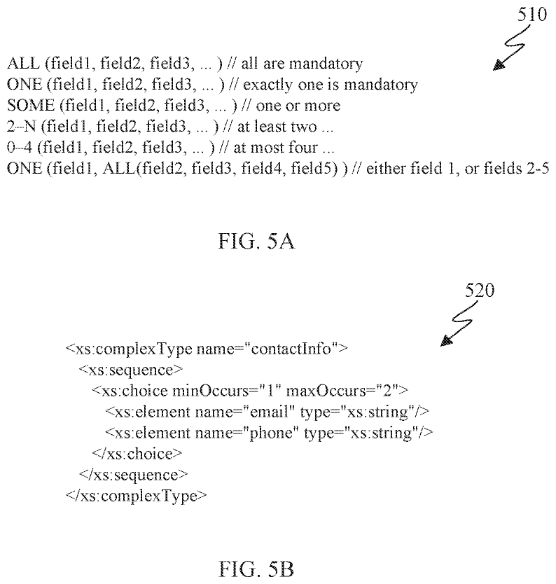

FIG. 5A depicts expressions 510 defining cardinality constraints for groups of input fields. As depicted, the first expression (“ALL”) represents a cardinality constraint requiring entry in all input fields. The second depicted expression (“ONE”) represents a cardinality constraint requiring an entry in exactly one input field in the group. The third depicted expression (“SOME”) represents a cardinality constraint requiring entry in one or more input fields in the group. The fourth depicted expression (“2−N”) represents a cardinality constraint requiring entry in at least two input fields in the group. The fifth depicted expression (“0-4”) represents a cardinality constraint where entry is not required but is allowed in as many as four input fields in the group. The final depicted expression (“ONE . . . ALL”) represents a cardinality constraint requiring entry in either field 1 or fields 2-5. The examples depicted in FIG. 5A represent a non-exhaustive set of cardinality constraints applied to groups of data input fields.

FIG. 5B depicts data structure definition 520 with a group cardinality constraint expressed using XML Schema. In this example, the group defined as “contactlnfo” is comprised of two elements: “email” and “phone.” The group cardinality constraint is defined by the minimum number of entries required and the maximum number of entries allowed, which correspond to “minOccurs” and “maxOccurs,” respectively. In this example, “minOccurs” equals one and “maxOccurs” equals two. In other words, at least one entry is required and at most two are allowed. While the data definition depicted in FIG. 5B is expressed using XML Schema language, it should be appreciated that in other embodiments, the data definition may be expressed using other data description languages.

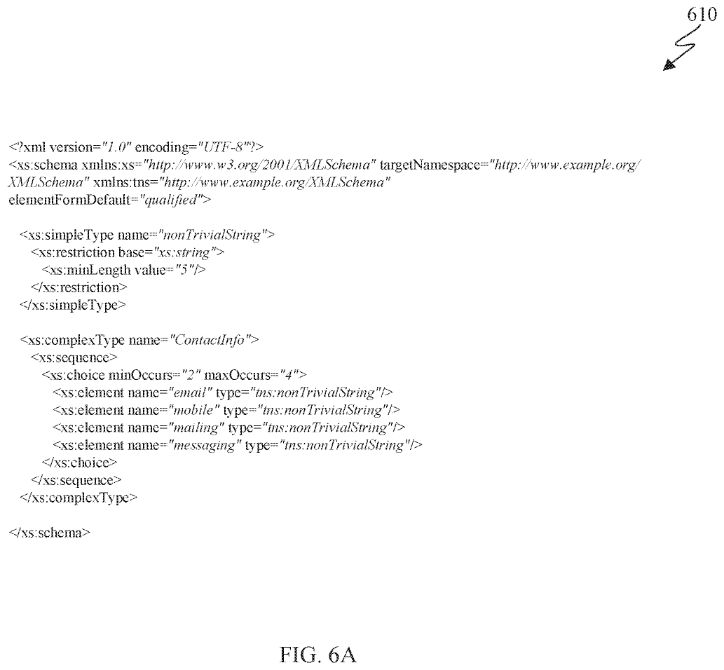

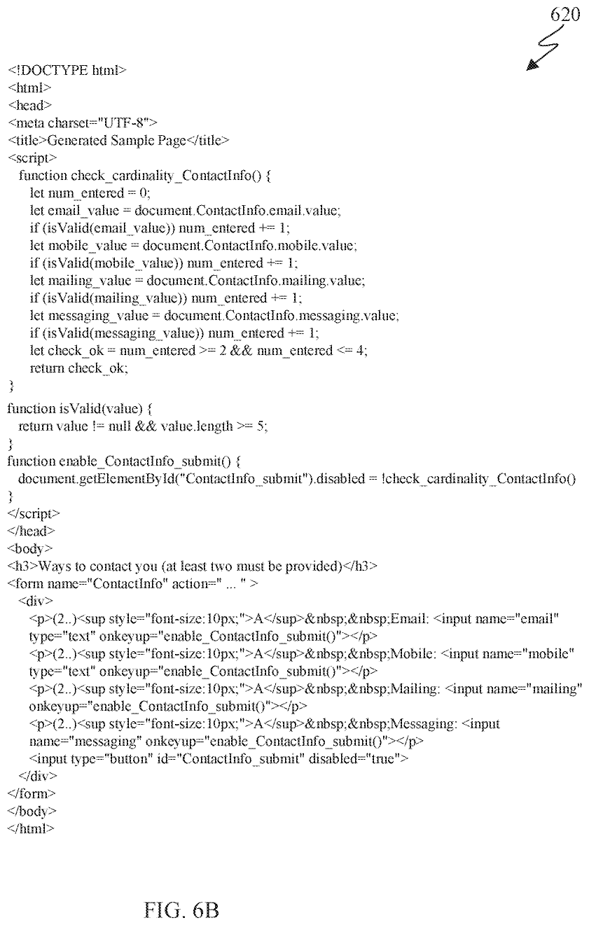

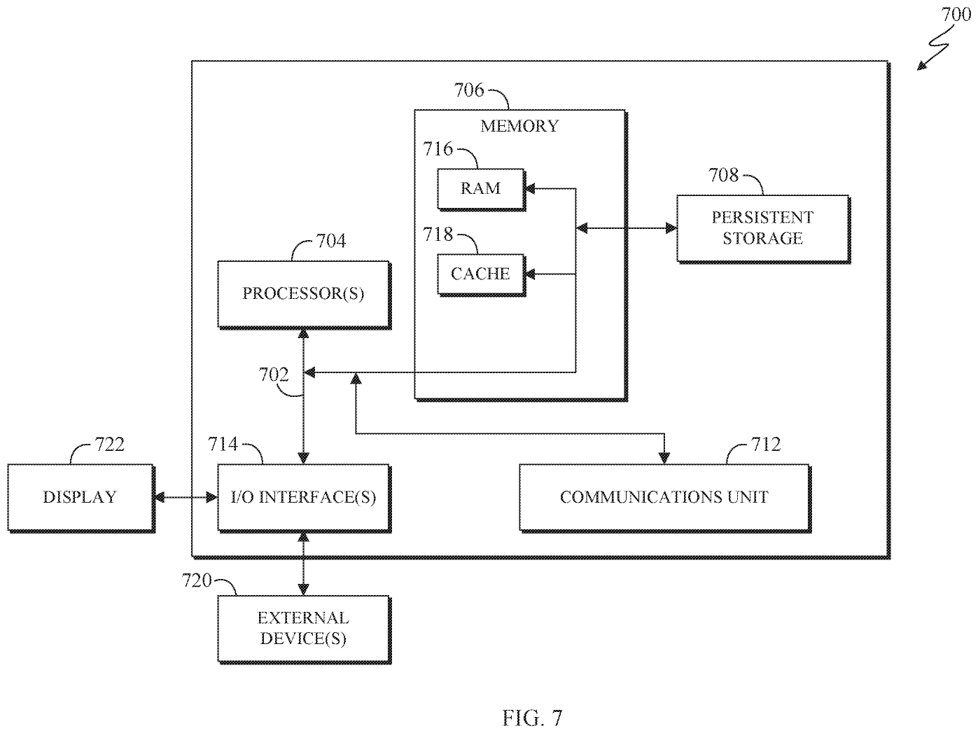

FIG. 6A depicts example data definition 610, expressed using XML Schema language, with a group cardinality constraint. As depicted, the group is defined by the “complexType” “ContactInfo” and is comprised of four elements: “email,” “mobile,” “mailing,” and “messaging.” The group cardinality constraint is defined by the minimum number of entries required and the maximum number of entries allowed, which correspond to “minOccurs” and “maxOccurs,” respectively. In this example, minOccurs equals 2 and maxOccurs equals 4, therefore the group cardinality constraint may be described as “at least 2 entries and no more than 4.” While the data definition depicted in FIG. 6A is expressed using XML Schema language, it should be appreciated that in other embodiments, the data definition may be expressed using other data description languages.

FIG. 6B depicts example code 620 corresponding to user interface code (expressed using HTML) and group cardinality validation logic (expressed using JavaScript) created in accordance with the group cardinality constraint visualization and validation method 200 described in FIG. 2. As depicted, the cardinality validation logic generates a user interface containing a group of input fields bound by a shared cardinality constraint. In this example, the four input fields correspond to the four elements in the data definition depicted in FIG. 6A. Each input field is annotated with a cardinality constraint and a group indicator. In this example, the indicator is “(2 . . . )^{A}”, indicating that at least two entries must be completed for all input fields annotated with a superscript “A”. This cardinality constraint corresponds to the minimum number of entries required and maximum number of entries allowed provided in the data definition 610 in FIG. 6A. In this example, the function “check_cardinality_ContactInfo( )” is defined to enable the “Submit” button if the group cardinality constraint is satisfied, that is, if the number of entry fields receiving values is not less than the minimum required and not more than the maximum allowed, and each value entered in a field satisfies the corresponding data value constraint, if one was specified in the schema. The data value constraints apply to the entry of an individual input field and may include, but are not limited to, length of input, datatype, and pattern. While the user interface is expressed using HTML, it should be appreciated that in other embodiments, the user interface may be expressed using other markup languages. While the visualization and validation logic are expressed using JavaScript, it should be appreciated that in other embodiments, the logic may be expressed using other programming languages.

FIG. 7 depicts a block diagram of components of computing system 110 in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

As depicted, the computer 700 includes communications fabric 702, which provides communications between computer processor(s) 704, memory 706, persistent storage 708, communications unit 712, and input/output (I/O) interface(s) 714. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 716 and cache memory 718. In general, memory 706 can include any suitable volatile or non-volatile computer-readable storage media.

One or more programs may be stored in persistent storage 708 for access and/or execution by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 712, in these examples, provides for communications with other data processing systems or devices. In these examples, communications unit 712 includes one or more network interface cards. Communications unit 712 may provide communications through the use of either or both physical and wireless communications links.

I/O interface(s) 714 allows for input and output of data with other devices that may be connected to computer 700. For example, I/O interface 714 may provide a connection to external devices 720 such as a keyboard, keypad, a touch screen, and/or some other suitable input device. External devices 720 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 708 via I/O interface(s) 714. I/O interface(s) 714 also connect to a display 722.

Display 722 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for applying a group cardinality constraint to a set of two or more input fields, the method comprising:
receiving a schema element corresponding to a set of two or more input elements, wherein the schema element comprises at least a data structure definition and a group construct of the schema element;
processing the group construct to identify a data entry limitation corresponding to the set of two or more input elements;
assigning a group cardinality constraint indicator to the identified data entry limitation;
generating a set of two or more input fields corresponding to the set of input elements, wherein each input field is annotated with the assigned group cardinality constraint indicator; and
presenting the generated set of two or more input fields on a user interface.

2. The computer implemented method of claim 1, further comprising assigning a group indicator to the identified data entry limitation.

3. The computer implemented method of claim 2, wherein the identified data entry limitation corresponds to a minimum number of required entries.

4. The computer implemented method of claim 2, wherein the data entry limitation corresponds to a maximum number of entries allowed for the group.

5. The computer implemented method of claim 1, further comprising generating validation code corresponding to the generated set of two or more input elements.

6. The computer implemented method of claim 5, further comprising combining the generated validation code for the generated group of two or more input fields with additional validation logic.

7. The computer implemented method of claim 5, wherein:
the validation code includes one or more validations of data value constraints; and
each data value constraint of the one or more data value constraints indicates a condition that at least one input element must satisfy.

8. A computer program product for applying a group cardinality constraint to a set of two or more input fields, the computer program product comprising:
one or more computer readable storage media and program instructions stored on the one or more computer readable storage media, the program instructions comprising instructions to:
receive a schema element corresponding to a set of two or more input elements, wherein the schema element comprises at least a data structure definition and a group construct of the schema element;
process the group construct to identify a data entry limitation corresponding to the set of two or more input elements;
assign a group cardinality constraint indicator to the identified data entry limitation;
generate a set of two or more input fields corresponding to the set of input elements, wherein each input field is annotated with the assigned group cardinality constraint indicator; and
present the generated set of two or more input fields on a user interface.

9. The computer program product of claim 8, further comprising instructions to determine a group size corresponding to the identified data entry limitation.

10. The computer program product of claim 9, wherein the identified data entry limitation corresponds to a minimum number of required entries.

11. The computer program product of claim 9, wherein the data entry limitation corresponds to a maximum number of entries allowed for the group.

12. The computer program product of claim 8, further comprising instructions to generate validation code corresponding to the generated set of two or more input elements.

13. The computer program product of claim 12, further comprising instructions to combine the generated validation code for the generated group of two or more input fields with additional validation logic.

14. The computer program product of claim 12, wherein:
the validation code includes one or more validations of data value constraints; and
each data value constraint of the one or more data value constraints indicates a condition that at least one input element must satisfy.

15. A computer system for applying a group cardinality constraint to a set of two or more input fields, the computer system comprising:
one or more computer processors;
one or more computer-readable storage media;
program instructions stored on the computer-readable storage media for execution by at least one of the one or more processors, the program instructions comprising instructions to:
receive a schema element corresponding to a set of two or more input elements, wherein the schema element comprises at least a data structure definition and a group construct of the schema element;
process the group construct to identify a data entry limitation corresponding to the set of two or more input elements;
assign a group cardinality constraint indicator to the identified data entry limitation;
generate a set of two or more input fields corresponding to the set of input elements, wherein each input field is annotated with the assigned group cardinality constraint indicator; and
present the generated set of two or more input fields on a user interface.

16. The computer system of claim 15, further comprising instructions to determine a group size corresponding to the identified data entry limitation.

17. The computer system of claim 15, wherein the identified data entry limitation corresponds to a minimum number of required entries.

18. The computer system of claim 16, wherein the data entry limitation corresponds to a maximum number of entries allowed for the group.

19. The computer system of claim 15, further comprising instructions to generate validation code corresponding to the generated set of two or more input elements.

20. The computer system of claim 19, further comprising instructions to combine the generated validation code for the generated group of two or more input fields with additional validation logic.
